(19) United States
(12) Patent Application Publication
(10) Pub. No.: US 2008/0023441 A1
(43) Pub. Date: Jan. 31, 2008

(54) METHOD OF DEEP ETCHING

(76) Inventor: Te-Keng Tsai, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/550,427

(22) Filed: Oct. 18, 2006

(30) Foreign Application Priority Data
Jul. 26, 2006 (TW) 095127293

(51) Int. Cl. C03C 25/68; C23F 1/00

(52) U.S. Cl. 216/58; 216/67; 216/72

(57) ABSTRACT

A method of deep etching is disclosed. Initially, a wafer is provided, and a patterned mask having at least an opening to expose a surface of the wafer is formed on the surface of the wafer. A deposition process is performed to form a polymer layer on the patterned mask and a part of the surface through the opening. And accordingly, a plasma etching process is performed to remove the polymer layer and to etch the surface through the opening to form a deep opening. An oxide layer is formed on a sidewall of the deep opening to protect the sidewall during the plasma etching process. The deposition process and the plasma etching process are repeated alternatively until the deep opening has a predetermined aspect ratio. The method of the invention etches the wafer anisotropically and forms a deep opening having a hydrophilic surface of the sidewall.

### BACKGROUND OF THE INVENTION

1. Field of the Invention

The present invention is related to a method of deep etching, and particularly to a method of deep etching in which a deposition process and a plasma etching process are repeated alternatively.

2. Description of the Prior Art

Micro-electromechanical system (MEMS) devices are tiny 3D-structures, such as circuits, sensors, and actuators, formed on wafers by microminiaturization technology, and are able to make difficult actions. MEMS technology is a multi-disciplinary integrated technology based on integrated circuits and other techniques including electronics, mechanics, optics, and material science etc. The structure of MEMS device includes immobile structures, such as probes, openings or holes; or mobile structures, such as springs, shafts, or gear wheels. The above-mentioned MEMS structures may be formed by wafer-bonding and bulk micromachining to form micro-fluid structures. At present, the MEMS technology is used to manufacture commercial products, such as digital micro-mirror devices (DMD), inkjet heads, actuators, or blood cell counters.

Nowadays, most microstructures are formed by etching wafers. Methods of etching wafers include a wet etching process, such as anisotropic wet chemical etching, or a dry etching process, such as deep reactive ion etching (DRIE). DRIE is a highly noticed etching method to etch wafers anisotropically. The feature of DIRE is quite different from anisotropic wet etching. DRIE is often utilized to form deep openings having a large aspect ratio. FIG. 1 illustrates a cross-sectional view of an exemplary deep trench formed by conventional DRIE process. A silicon wafer 10, which has a patterned hard mask layer 12 disposed over it, is etched to form a deep trench 14 using the prior art DRIE method. The conventional DRIE process encounters problems of disarranged etching parameters, unstable etching conditions, or undesirable effects resulting from the lattice structure of the silicon wafer 10. Therefore, the deep trench 14 has a number of structural flaws, for example, notch-like features 16 as well as bowed-like features 18, which result from undercutting of the hard mask 12. The structural flaw will result in problems of critical dimension (CD) bias and less precision.

### SUMMARY OF THE INVENTION

It is therefore a primary objective of the present invention to provide a method of deep etching, and particularly to a method in which a polymer deposition process and an anisotropic plasma etching process are repeated alternatively to form a deep opening having hydrophilic surface of the sidewall and great aspect ratio.

According to the invention, a method of deep etching is provided. Initially, a wafer having a patterned mask on a surface thereof is provided. The patterned mask has at least an opening to expose the surface of the wafer. A deposition process is performed to form a polymer layer on the patterned mask and the surface of the wafer. A plasma etching process is performed to form a deep opening on the surface of the wafer through the opening. The plasma etching process uses an etching gas, which includes oxygen, and forms an oxide layer on a sidewall of the deep opening. And accordingly, the deposition process and the plasma etching process are repeated alternatively until the deep opening has a predetermined aspect ratio.

The method of the present invention has advantages of good-anisotropic features, less critical dimension bias and flexibility, and is able to form delicate MEMS devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a cross-sectional view of an exemplary deep trench formed by conventional DRIE process.

FIGS. 2 to 5 are schematic diagrams illustrating a method of deep etching according to a preferred embodiment of the present invention.

FIG. 6 shows the steps involved in the method of deep etching according to the present invention.

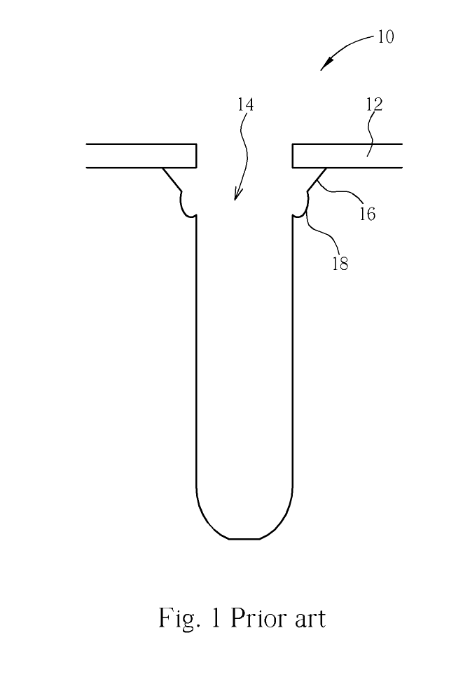

### DETAILED DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

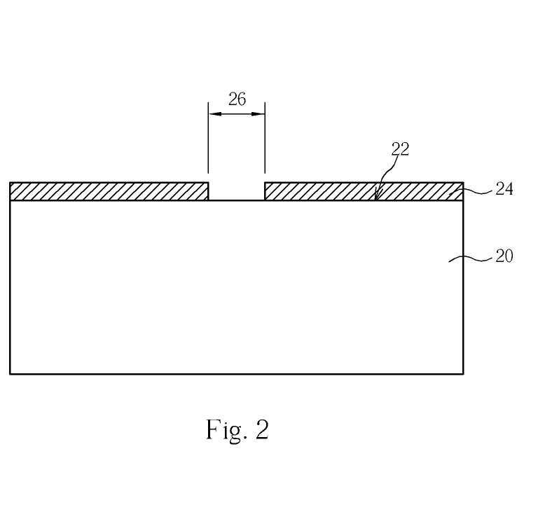

FIGS. 2 to 5 are schematic diagrams illustrating a method of deep etching according to a preferred embodiment of the present invention. As shown in FIG. 2, a wafer 20 is provided. A patterned mask 22 having at least an opening 26 is formed on a surface 22 of the wafer 20. The opening 26 exposes the surface 22 of the wafer and defines the position of a deep opening formed in the following processes. The wafer 22 is a silicon wafer and other kinds of wafers can also be used, for instance, a single crystalline silicon wafer, an amorphous crystalline silicon wafer, or a poly crystalline silicon wafer. The patterned mask 24 disposed on the surface 22 of the wafer may comprise photoresist, metal, silicon nitride, tetra-ethyl-ortho-silicate (TEOS), or other materials of high-selectivity and anisotropic features.

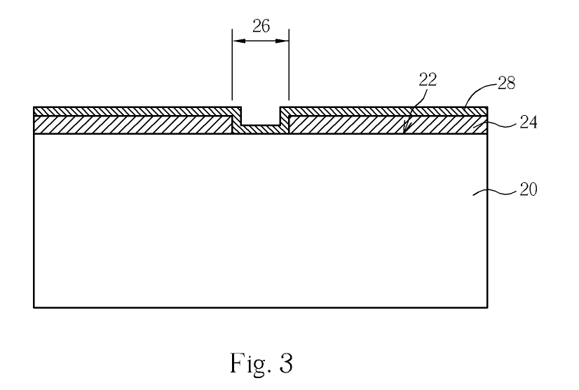

As shown in FIG. 3, the wafer 20 is transferred into a chamber and is disposed on a lower electrode of the chamber. A deposition process is performed. In this preferred embodiment, the deposition process uses octafluorocyclobutane (C₄F₈) as a precursor to form a polymer layer 28 of fluorocarbon (nCFx). The deposition may use tetrafluoromethane (CF₄) or other kinds of precursors to form the polymer layer 28. The deposition process uses a deposition gas preferably comprising 70-120 standard cubic centimeters per minute (sccm) of C₄F₈ at a chamber pressure between 35-55 mT. And the deposition gas is preferably generated by supplying 500-1500 W of RF power to the upper electrodes and 0 W to the lower electrode.

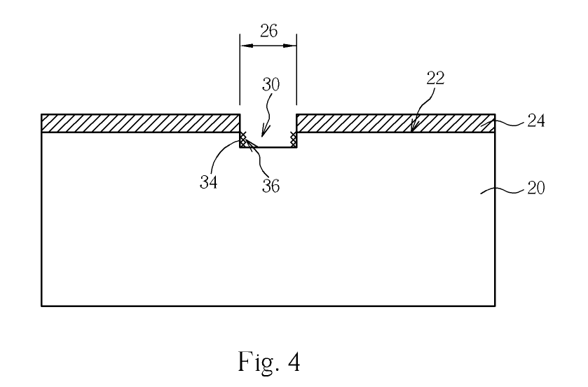

A plasma etching process is performed after the polymer layer 28 formation. The plasma etching process uses an etching gas including a precursor to form halogen, an inert gas to enhance bombardment, and oxygen (O₂) reactant. In this preferred embodiment, the halogen precursor and the inert gas are sulfur hexafluoride (SF₆) and argon (Ar), respectively. The etching gas preferably comprises 180-260 sccm of SF₆, 40-80 sccm of O₂ and 100-400 sccm of Ar, and is preferably generated by supplying 1500-2500 W of RF power to the upper electrode and 18-30 W of RF power to the lower electrode. As shown in FIG. 4, the etching gas uses fluoride (F⁻) released from SF₆ while utilizing Ar bombardment to remove the polymer layer (not shown) formed in the prior deposition process. The etching gas also etches the surface 22 of the wafer through the opening 26 to form a deep opening 30. Thereafter, the wafer 20 is oxidized by oxygen reactant and an oxide layer 36, for instance, silicon oxide, is formed on a sidewall of the deep opening 30 after the polymer layer (not shown) is removed. The plasma etching process is a physical etching process using Ar bombardment to remove the surface 22 of the wafer 20 perpendicular to the direction of Ar bombardment. However, the plasma etching process merely removes the sidewall 34, the polymer layer (not shown) on the sidewall 34, or the oxide layer 36 on the sidewall 34, which are parallel to the direction of the Ar bombardment. Therefore, the oxide layer 36 protects the sidewall 34 during the plasma etching process, and the method of the invention etches the wafer 20 anisotropically.

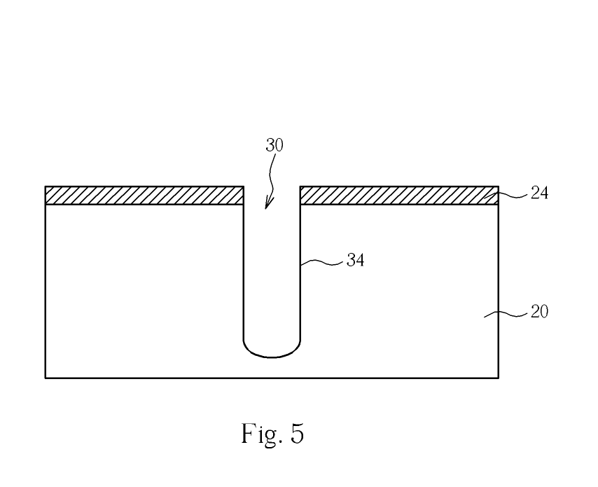

The method of the present invention alternatively repeats the aforementioned deposition process and the plasma etching process until the deep opening 30 has a predetermined depth. As shown in FIG. 5 the profile of the sidewall 34 is substantially vertical, and the deep opening 30 has an aspect ratio greater than approximately 10:1, even greater than approximately 35:1. It should be noticed that the method of the present invention uses the polymer layer formed in the deposition process to protect the sidewall of the deep opening, and then uses the oxide layer formed in the plasma etching process to protect the sidewall from etching. The method of the invention will not be affected by the lattice structure of the wafer, and therefore the deep opening or a hole formed by the method of the invention will have a high aspect ratio, respectively.

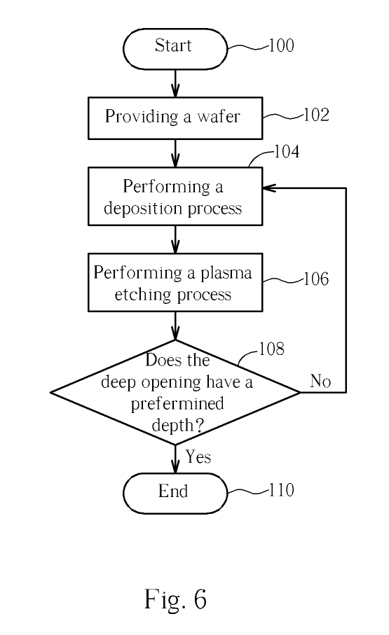

To facilitate the method of the invention, FIG. 6 shows the steps involved in the method of deep etching according to the present invention. The method starts at step 100 and begins at step 102 when a wafer having a patterned mask on the top surface thereof is provided. A deposition process is performed at step 104 and a plasma etching process is performed to form a deep opening on the top surface at step 106. Ajudging step is performed at step 108. The procedure of the method returns to step 104 and repeats step 104 and step 106 when the deep opening has a depth less than the predetermined depth. Otherwise, the procedure will continue and the method ends at step 110. Since the method of the invention repeats steps of deposition and etching, proper gases should be used to keep balance between deposition and etching to the deep opening having a vertical profile.

Instead of the described precursors, such as C₄F₈ and CF₄ for the deposition process, other precursors of the polymer layer are allowed to be used in the deposition process, for example, perfluorinated compounds (PFC), styrene-like monomer, or ether-like fluorine compounds. In addition, other etching gases, for example, nitrogen trifluoride (NF₃), CF₄, or other compounds capable of releasing F⁻, are used for the plasma etching process. The plasma etching process may be performed with other kinds of halogens instead of F⁻; for instance, chloride (Cl⁻) can be used in the plasma etching process. The precursor of the halogen will be selected depending on the species of the halogen.

According to the aforementioned embodiment, the method of the deep etching uses the polymer layer formed the deposition process to increase the selectivity between the patterned mask and the wafer and the oxide layer formed during the plasma etching process, and alternatively repeats the deposition process and the plasma etching process to form a deep opening having a hydrophilic surface of the sidewall and high aspect ratio. The deep opening formed by the method of the invention has less CD bias and the profile of the sidewall is approximately vertical. The parameters of the method are flexible and can be adjusted depending on the type of the wafer or other requirements. It should be noticed that the deep opening formed by the method of the invention not only has a vertical profile of the sidewall, but also has a hydrophilic surface. Moreover, the method of the invention is suitable to manufacture ink jet heads, blood cell counters, biochips, or the products having deep openings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of deep etching, comprising:
providing a wafer;
forming a patterned mask on a surface of the wafer, the patterned mask having at least an opening to expose the surface of the wafer;
performing a deposition process to form a polymer layer on the patterned mask and the surface of the wafer;
performing a plasma etching process to etch the surface of the wafer through the opening and to form a deep opening, the plasma etching process using an etching gas that comprises oxygen to form an oxide layer on a sidewall of the deep opening; and
repeating the deposition process and the plasma etching process alternatively until the deep opening has a predetermined aspect ratio.

2. The method of claim 1, wherein the plasma etching process removes the polymer layer formed during the deposition process.

3. The method of claim 1, wherein the polymer layer comprises fluorocarbon.

4. The method of claim 1, wherein a precursor of the polymer layer comprises octafluorocyclobutane (C₄F₈).

5. The method of claim 1, wherein the etching gas comprises a fluoride precursor.

6. The method of claim 5, wherein the fluoride precursor comprises sulfur hexafluoride (SF₆).

7. The method of claim 1, wherein the etching gas comprises argon (Ar).

8. The method of claim 1, wherein the predetermined aspect ratio is greater than 10:1.

9. The method of claim 1, wherein the deep opening has a hydrophilic surface of the sidewall.
